(19) United States
(12) Patent Application Publication
(10) Pub. No.: US 2008/0221927 A1
(43) Pub. Date: Sep. 11, 2008

(54) Web-Enabled, Evidence Based Medical Diagnostic System

(76) Inventor: Victor Levy, Clearwater, FL (US)

Correspondence Address: VANTAGE LAW PLLC, 355 NW GILMAN BLVD., SUITE 203, ISSAQUAH, WA, 98027, US

(21) Appl. No.: 11/383,246

(22) Filed: May 15, 2006

Related U.S. Application Data
(63) Continuation-in-part of application No. 09/698,787, filed on Oct. 27, 2000, now Pat. No. 7,076,437.
(60) Provisional application No. 60/162,564, filed on Oct. 29, 1999.

(51) Int. Cl. G06F 19/00

(52) U.S. Cl. 705/3

(57) ABSTRACT

A web-based medical diagnostic system predicts diseases via the use of likelihood ratio calculations. Likelihood ratios are multiplied against pre-test odds for diseases to predict post-test odds that will guide a physician to a diagnosis. Each likelihood ratio is calculated on the basis of statistically accrued data and in response to questions and answers directed to patients or test results. Likelihood ratios are scaled infinitely beyond a simple 2×2 matrix, with an independent likelihood matrix created for individual patient responses or test results which are treated as independent variables in the system. The number of predicted diseases and diagnostic outcomes is also infinitely scalable.

### RELATED APPLICATIONS AND INFORMATION INCORPORATED BY REFERENCE

This specification is a continuation-in-part of application Ser. No. 09/698,787, filed on Oct. 27, 2000, and claims priority on provisional Application Ser. No. 60/162,564, filed on Oct. 29, 1999. Application Ser. No. 09/698,787 is set for publication as U.S. Pat. No. (to be added). The entire disclosure of application Ser. No. 09/698,787, which was previously published, is incorporated by reference in this continuation-in-part (“CIP”) application. This application is filed as a CIP because it describes certain enhancements to diagnostic methods that were not originally described in provisional Application Ser. No. 60/162,564. Specifically, this CIP application describes a calculation matrix for calculating post-test odds for a plurality of diseases or diagnostic outcomes at the same time. Nevertheless, the basic statistical techniques that provide system scalability using likelihood ratios, as described below, were previously disclosed in the provisional patent application.

### TECHNICAL FIELD

The invention disclosed here relates to methods and processes for statistically analyzing and diagnosing medical symptoms and diseases.

### BACKGROUND OF THE INVENTION

If adopted by the healthcare industry, this invention will significantly improve healthcare and/or reduce healthcare costs. In general, this invention relates to treatment option tools (“profiler systems”) that are web-based or network-based. The invention provides an improved means for the preliminary diagnosis of a disease, or other medical complaint, based on accumulated patient data.

Systems that provide this general functionality are known and, on a rudimentary level, are based on fundamental diagnostic procedures that evolved in parallel with the evolution of modern medicine. That is, doctors ask patients questions, conduct tests, and generate diagnoses as a result of patient answers and related test results. The diagnoses are based on this acquired information, coupled to the doctor's prior personal experiences, further coupled to the doctor's access to information and data concerning the experiences of others.

On the most fundamental level, diagnosing and treating medical complaints is based on questions and answers done in a sequence that is based on a combination of experience and logic. With the advent of information age technologies, this fundamental method of diagnosing and treating medical complaints has been transposed to software and evolved into many different forms of computer based systems, including question and answer systems that are available to members of the public or doctors on the Internet (“profiler systems”).

An example of a system that provides web-based access to the public is the University of South Carolina's (“USC”) NexCura patient profiler system that is accessible via www.nexcura.com. The USC system is not conceded to be prior art, although the general idea of web-based profiler systems, at least in limited form, probably is prior art.

While it might be the subject of lengthy debate, for the purpose of describing the present invention relative to the prior art, the problem with profiler systems tends to be two-fold in nature. First, there is no universal standardization of electronic data in existing profiler systems. In other words, different entities (universities, medical research institutions, etc.) are now creating profiler systems by essentially writing their own dedicated software. While they may share many common and well-known diagnostic techniques, they are nevertheless generating proprietary and distinct data bases that are not standardized in a way that promotes easy electronic sharing or cross-use of data.

For example, if a patient complains of chest pain, then a typical question asked by a doctor and, therefore, by a software-based profiler system is: does the patient smoke? If the answer to that question is “yes,” then it immediately triggers subsequent questions that follow a particular diagnostic path due to known correlations between smoking and heart disease or other ailments.

Profiler system software is logically written to follow, as much as possible, the same general logical rules that a doctor would follow. And, these systems can be designed to accumulate data that is later used to refine and improve the diagnostic path and accuracy of the system. Problems arise, however, when different organizations or entities independently design systems of this kind, because data generated by one is not necessarily easy to share or exchange with other systems. In part, this may be due to simple data formatting attributable to the fact that different software writers may design different numeric fields or templates for data input or output. It is not impossible, but transferring data from one system to another may require writing a conversion program.

Of equal or greater importance, conventional profiler systems are also difficult to modify or adapt as new information comes to light concerning diagnostic techniques or treatments—which has been part and parcel to the practice of medicine since the beginning. While they are universally based on historical information or statistics, profiler systems are balanced toward “rules based” methodology or rules based systems.

Rules based systems tend to output solutions as though there is a “yes” or “no” answer to each new variable (i.e., a variable being a physician question, information about symptoms, test results, etc.) that is input. For example, a rules based profiler system may begin by asking the user the question mentioned above, i.e., does the patient smoke? The answer may determine the next question, and so forth, which leads to “branching” paths of software logic until the most likely solution or diagnosis is obtained.

Systems of this type are universally flawed and have long been the subject of criticism in the medical community. One problem with rules based profiler systems is that they require a marriage between physician skills and programming skills. These systems have shortcomings because a doctor's experience is not always amendable to logical reproduction in a software flow chart. Another problem with these systems is that implementing change may not be straight forward. In other words, if it is desired to introduce a new variable into the system (e.g., a new question or newly discovered test result), then the question becomes one of how to best rewrite the code. The programmer needs to know where the variable should be inserted into the existing logical flow of previously written code—with the potential of creating a rippling effect of complexities that require changes throughout the system software. It is not an impossible task, but it is also not the best one, given that the programmer may lack, or probably lacks, a doctor's expertise.

Regardless of the above problems, the medical community has long recognized the potential of profiler systems as medical diagnostic tools. The intent and purpose of these systems is not to replace the doctor, but to instead give speed and increased accuracy to diagnoses, particularly for new patients or incoming patients. To further make the point, given the high costs of medical insurance and hospitalization, having a reliable way of quickly and accurately discerning the difference between heart attack and indigestion when a patient complains of chest pain will serve to reduce healthcare costs significantly. It is understandable that too many patients are unnecessarily admitted to hospitals because of concerns about mistakenly turning away those who need to be admitted. Profiler systems have been viewed as a tool that may help both ways (i.e., appropriate admissions and turn-aways), if the problems described above can either be eliminated or at least improved upon.

The present invention, like the systems described above, relies on its own proprietary templates for the input of data. However, what sets the invention apart from other systems known to be in the art is its ability to seamlessly add or subtract variables without having the programming problems described above while, at the same time, improving upon the reliability of system diagnoses. Because it is based on the accrual of statistical data, a system constructed in accordance with the invention is mathematically driven in an automatic manner toward an accurate prediction of the likelihood of disease.

### SUMMARY OF THE INVENTION

To understand the invention described and claimed here, one needs to first understand the difference between a rules based profiler system and an evidence based system. As indicated above, rules based systems require people with medical expertise, on the one hand, and computer programming expertise, on the other. This strikes an uneasy balance between medical expertise and programming skills. The person who understands the medical problems may lack programming expertise, while the person with programming experience may not understand the best path to follow in writing code that diagnoses a medical complaint.

Both rules based and evidence based profiler systems are dependent on statistically accrued data. In the case of the rules based system, the implementation and use of the data is highly dependent on the skills of the programmer. In an evidence based system, the skills of the programmer are minimized or negated because diagnoses are simply based on statistics that accrue over time.

The problem with an evidence based system lies in how to implement and accrue statistics in a usable way, and on an ongoing and ever-expanding basis—including updating predictive calculations on an ongoing basis. The present invention solves this problem via a unique implementation of Bayesian statistical theory, and likelihood ratios, which provides a better predictive tool, in the first place, and one that makes it easy for the programmer to amend the system without significantly rewriting the logical aspects of software, in the second.

Likelihood ratios are well-known and typically calculated from a 2×2 matrix, as will be further described below. In common form, likelihood ratios statistically associate a variable (e.g., a test result) to a specific outcome by creating a real number that indicates the likelihood of an event. There can be both “positive” and “negative” likelihood ratios that denote “association” or “lack of association,” respectively, between the variable and the outcome. To explain further, a positive likelihood ratio between exercise and heart disease would have a value “less than 1,” which means those who exercise have reduced instances of heart disease. A negative likelihood ratio between regular exercise and heart disease would have a value “greater than 1” which means that those who do not exercise (the negative association) have increased instances of heart disease.

Thus, in a profiler system, a patient entering a hospital complaining of chest pain has certain pre-examination or pre-test odds of having heart disease, simply because the patient complains of chest pain. The physician asks the question: “do you regularly exercise?” If the answer is “yes,” then the statistical likelihood ratio generated from that response is a real number that is a fraction less than one—which essentially means that a person who exercises is less likely to have heart disease. Multiplication of that fraction with the pre-test odds number drives downward the mathematical odds of heart disease as the reason for the complaint. On the other hand, if the answer is “no,” then a negative likelihood ratio is generated that creates a fraction greater than one—which conversely indicates that persons who do not exercise are more likely to have heart disease. Multiplication of that fraction with the pre-test odds number therefore drives the odds upward.

In accordance with the invention, different likelihood ratios are multiplied together as an array with a pre-test odds number to create a post-test odds number, with each likelihood ratio serving as an independent variable or an expression that results from an independent variable (i.e., a test result or an answer to a question, etc.). This is an important distinguishing factor that sets the present invention apart from the prior art because, in the context of medical diagnostics, it neutralizes the need to ask questions and/or undertake tests in an optimized sequence—which is an inherent problem with writing software for rules based systems.

For example, the code writer who is developing a rules based system needs to consider the following: what is the best, first question to ask that will provide the most efficient path to an accurate diagnosis? In the above example, the best first question might be “do you exercise?” Or a doctor with experience might tell the programmer that the best first question to ask of a patient complaining of chest pain is “do you smoke?” It is not difficult to understand that judgment is required to program a system of this kind in a way that functions effectively. The present invention provides a way to predict the most likely diagnosis while being essentially neutral to the path that one takes to get there.

It is true that an evidence based system, that uses likelihood ratios in accordance with the present invention, will probably be designed to ask the best or most obvious questions first. Nevertheless, the mathematical techniques of multiplying likelihood ratios together as independent variables in an array neutralizes or attenuates the need to have the best-ordered, or best logical sequence of questions asked, as is typical of present-day rules based systems. In the present invention, if the best question is asked at a later point in time during a diagnostic process, the instantaneous generation of a high or low value likelihood ratio in the array stands to dramatically alter the pre-test odds number at the time the question is asked. As is further explained in this specification, the order of the question (or test result) is essentially divorced or independent from any logic that comes into play as to when the question should be asked (or a particular test conducted). This simply removes the programmer from the process.

An important related aspect of the invention is that it becomes very adaptive to the addition of new variables that lead to the prediction of diagnostic outcomes. In many or most instances, new variables, in the context of the invention, will be new tests developed for predicting specific diseases. If, for example, a highly reliable test is developed that did not exist before, it is easy to add a likelihood ratio relating to the test as another variable that is multiplied against other likelihood ratios already in the array:

Pre-test Odds X LR₁ X LR₂ X LR₃ X LRn=Post-test Odds

Referring to the previously described example concerning how an answer to a question about exercise can drive predictive odds of heart disease upward or downward, a highly reliable definitive test generates a strong likelihood ratio as a multiplication factor that creates a strong swing in the calculated post-test odds. However, it does not matter if the likelihood ratio appears near the beginning of the array of likelihood ratios that are multiplied together or near the end—it impacts the post-test prediction the same way in either case.

As suggested above, multiplying likelihood ratios as an array makes it easier to add new variables in an array or, conversely, remove variables automatically by virtue of the simple fact that likelihood ratios are based purely on statistics. To explain this last concept further, long term statistics may eventually demonstrate that a particular test does not establish that an outcome is more likely or less likely—in such case, the likelihood ratio calculation becomes mathematically driven toward “one”—which is mathematically neutral relative to impacting the array or creation of a post-odds result. In such case, in accordance with the invention, there is no need to rewrite logical code because the accumulated statistics themselves automatically wash-out the variable (i.e., create a likelihood ratio value of “one”).

Another aspect and significant advantage of the invention is that it can simultaneously predict post-test odds or post-test odds for a plurality of diseases or outcomes at the same time. Moreover, post-test odds can be recalculated for each and every disease, or outcome in the system, upon the answer of a single question, or upon conducting a single test, each one of which serves as an independent variable. The invention accomplishes this by creating what is essentially an infinitely scalable “calculation” matrix of cells that can be extended in two directions—horizontal and vertical.

One direction (horizontal) relates to the expansion of the number of variables and corresponding likelihood ratios, upon the addition of new diagnostic questions, new tests, or other relevant statistical data that are useful in making a statistical prediction of a certain outcome or disease. The second one (vertical) relates to the expansion of the list of diagnostic outcomes or diseases that are analyzed by the system—which can essentially be expanded infinitely to meet new numbers of diseases as they are discovered, or subcategories of an existing disease, as subcategories become established (e.g., lung cancer, pancreatic cancer, prostate cancer, breast cancer, etc. could be considered as subcategories of “cancer”).

According to the present invention, with the possible exception of cells containing pre-test odds and post-test calculations (further described below) each cell in the calculation matrix contains a likelihood ratio, calculated from accrued data. Each likelihood ratio, however, is calculated from a separate data template or likelihood ratio matrix that is essentially a subset matrix relative to the calculation matrix. In other words, in the calculation matrix, one cell will contain a real number corresponding to the value of a likelihood ratio. The real number corresponding to the likelihood ratio is calculated from a separate data matrix (or likelihood ratio matrix) that mathematically generates the likelihood ratio.

In optimum form, a row in the system calculation matrix will have a large number of cells with corresponding likelihood ratios running in the horizontal direction—to produce the above mathematical equation. As mentioned previously, each likelihood ratio results from an independent variable (i.e., question or test result or other) and is likewise calculated from its own, independent likelihood ratio matrix. Adding a new likelihood ratio in the row that corresponds to a newly discovered test, for example, simply requires adding another cell to each applicable row of the calculation matrix. Likewise, the numeric value of that cell is derived from the addition of a new and dedicated likelihood ratio matrix that is specific to the cell position within the calculation matrix and is also independently created and mathematically independent of other cell positions in the same calculation matrix row.

In accordance with the preferred version of the invention, each and every potential disease (or diagnostic outcome) in the system has a pre-test odds number assigned to it that is based on accumulated data from prior patients. To simplify, if a patient enters a hospital for no stated reason other than the patient is not feeling well, it is possible to define a statistical set of probabilities for a wide variety of potential diseases that the patient might have. To take it a step further, it is possible to monitor hospital entries and statistically establish that, as illustrative examples only, a certain percentage of hospital admissions relate to angina, pneumonia, urinary infection, broken bones, etc., and any and all complaints or diseases that cause someone to enter a hospital. This accumulated data enables one to predict, with varying degrees of reliability, the “pre-test odds” for any or all diseases or diagnostic outcomes in the system, simply because a patient enters a hospital with a complaint, and even before a single question is asked or test conducted.

In accordance with the invention, the pre-test odds number for each diagnostic outcome in the system is put in a cell of the calculation matrix—which creates a column of different pre-test odds in the calculation matrix. Each cell with a pre-test odds number is multiplied by a string or array of likelihood ratios in the same matrix row.

At this point it is appropriate to summarize how likelihood ratios are calculated from the likelihood ratio matrices described earlier. As described above, each variable or likelihood ratio is derived from its own statistically accrued data template or matrix that is also infinitely scalable beyond the 2×2 matrix form of conventional likelihood ratio calculation. In the present invention, and as an illustrative example only, if a patient enters a hospital and claims, “I have chest pain,” then a system in accordance with the invention has the capacity to generate a series of pre-test odds numbers for virtually every possible diagnosis. At that point in time going forward, the doctor or nurse may ask even the simplest question, such as, “how old are you?” Every answer has the capacity for creating a variable, or likelihood ratio for each pre-test odds number associated with a diagnostic outcome, based on statistically accrued data.

Accumulated statistics will indicate, for example, that persons who are older and complain of chest pain are more likely to have symptoms relating to angina, while persons who are young and complain of chest pain are more likely to have other complaints. According to the invention, a likelihood ratio is generated from the answer and inserted into the multiplication array described above for each disease in the system—which means that an entire column of likelihood ratios is generated for the calculation matrix upon answering a question or receiving a test result. This takes us to a description as to how likelihood ratios are calculated from a likelihood ratio matrix.

In the first instance, the likelihood ratio simply comes from pre-existing statistical data, with an additional likelihood ratio being added upon subsequent queries and test results. However, when the patient is diagnosed, then the matrix corresponding to each likelihood ratio is updated appropriately, thereby updating the accuracy of each likelihood ratio value for the next patient. Moreover, since each matrix used to calculate a likelihood ratio is divorced and independent from the other, each matrix can be scaled in size independent of the other, which simplifies programming if changes need to be made.

Each likelihood ratio that is calculated from a dedicated likelihood ratio matrix is calculated from accrued data using cell values of all cells within the likelihood ratio matrix, with no limits to matrix size (i.e., number of cells in horizontal and vertical directions). As will be further described below, this mathematical technique enables simultaneous calculation of post-test odds for all diseases or diagnostic outcomes in the system at the same time because, in preferred form, each likelihood ratio matrix has a series of rows corresponding to different diagnostic outcomes and a series of columns corresponding to the variable response (i.e., the specific answer to the patient question or test result). This matrix is similar to a spread sheet of cell values in a rectangular matrix. When the variable response is entered, the response is associated with the cell values in the column corresponding to the response. A likelihood ratio is generated from each cell value in that column, which creates what is essentially a vertical column of likelihood ratios from the likelihood ratio matrix, for inclusion in the calculation matrix described above.

While systems like the one summarized above are not intended to provide absolute answers, the present invention's reliance on purely statistical data (or an evidence based system) means that it inherently becomes more accurate as data is accumulated. How the invention accomplishes the above functionality will become more clear and apparent from the following description.

### BRIEF DESCRIPTION OF DRAWINGS

In the drawings, like reference numerals and letters refer to like parts throughout the various views unless indicated otherwise, and wherein:

FIG. 1 is a schematic view that illustrates a web-based or web-enabled medical diagnostic system constructed in accordance with the invention;

FIG. 2 is a flow chart that illustrates the functionality of the system;

FIG. 3 is a schematic view that illustrates how likelihood ratios are generated from one independent variable;

FIG. 4 is a likelihood ratio template that illustrates likelihood ratio values from data or cell values for different responses that correspond to the independent variable;

FIG. 5 is similar to FIG. 4, but illustrates underlying data or cell values in the template or matrix and also illustrates how likelihood ratios are calculated for each cell from all of the cell values in the template or matrix;

FIG. 6 is illustrative of examples of likelihood ratio values calculated from a likelihood ratio matrix, corresponding to one column in the matrix that relates to a specific response to a question or test result, and is meant to be used only for the sake of explanation and not the actual numbers depicted;

FIG. 7 illustrates a system calculation matrix and how likelihood ratios are multiplied in arrays against pre-test odds numbers for each diagnostic outcome in the system to produce post-test odds for each outcome, with the figure illustrating input of the first variable during a diagnostic sequence;

FIG. 8 is similar to FIG. 3, but illustrates likelihood ratio generation from a second variable;

FIG. 9 is similar to FIG. 4, but corresponds to the second variable illustrated in FIG. 8;

FIG. 10 is similar to FIG. 5, but illustrates sample cell values for the second variable, with the cell values to be used to calculate likelihood ratios corresponding to the second variable;

FIG. 11 is similar to FIG. 6, and is illustrative of likelihood ratio values calculated from a likelihood ratio matrix, corresponding to one column in the matrix that relates to a specific response to a question or test result, and is meant to be used only for the sake of explanation and not the actual numbers depicted;

FIG. 12 is the calculation matrix previously illustrated in FIG. 7 and illustrates how likelihood ratios are multiplied in arrays against pre-test odds numbers for each diagnostic outcome in the system to produce post-test odds for each outcome, with the figure illustrating input of a second variable during a diagnostic sequence;

FIG. 13 is similar to FIGS. 6 and 11, but corresponds to numeric likelihood ratios for a third variable, the numbers depicted in the Fig. being shown for the sake of illustrative purposes only and not actual data;

FIG. 14 is the calculation matrix previously illustrated in FIGS. 7 and 12 and illustrates how likelihood ratios are multiplied in arrays against pre-test odds numbers for each diagnostic outcome in the system to produce post-test odds for each outcome, with the figure illustrating input of a third variable during a diagnostic sequence;

FIG. 15 is a flow chart that illustrates how accumulated or accrued data in likelihood ratio templates or matrices are updated upon reaching a conclusion as to a patient diagnosis; and

FIG. 16 is a flow chart that illustrates the programming advantages of an evidence-based system in accordance with the invention versus a rules-based system.

### BEST MODE FOR CARRYING OUT THE INVENTION

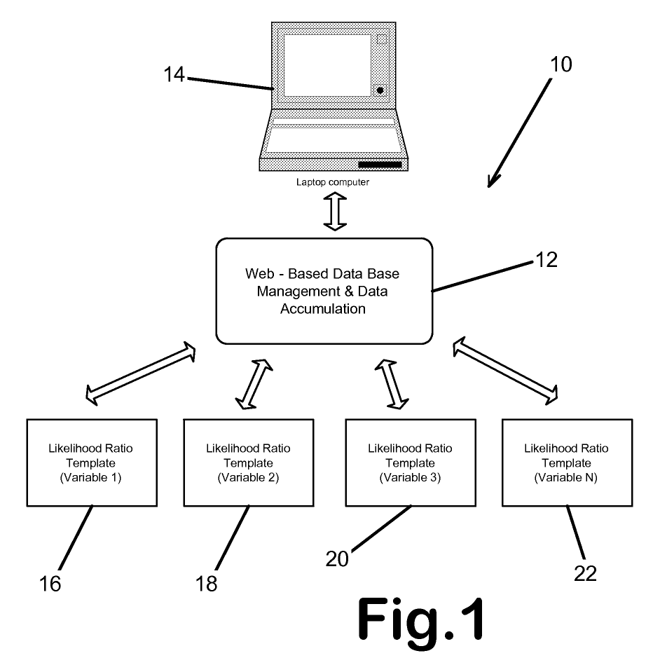

Referring now to the drawings, and first to FIG. 1, shown generally at 10 is a web-based system for generating medical diagnoses. It is to be understood that the system 10 can be implemented in a variety of different ways, so long as it stays true to the statistical or evidence-based implementation described here. In preferred form, all data will be accessible to users from a web-based host server 12 that could be located virtually anywhere in the world. Any laptop or other computer 14 with internet access would have appropriate password access to the system 10.

The system 10 includes a plurality of independent likelihood ratio templates or matrices 16, 18, 20, 22, corresponding to and illustrating the virtually infinite number of variables that may be generated to multiply against pre-test odds statistics that correspond to different diagnostic outcomes (i.e., diseases). Each likelihood ratio matrix 16, 18, 20, 22 represents statistically accrued data that is updated on an ongoing basis, as will be further described.

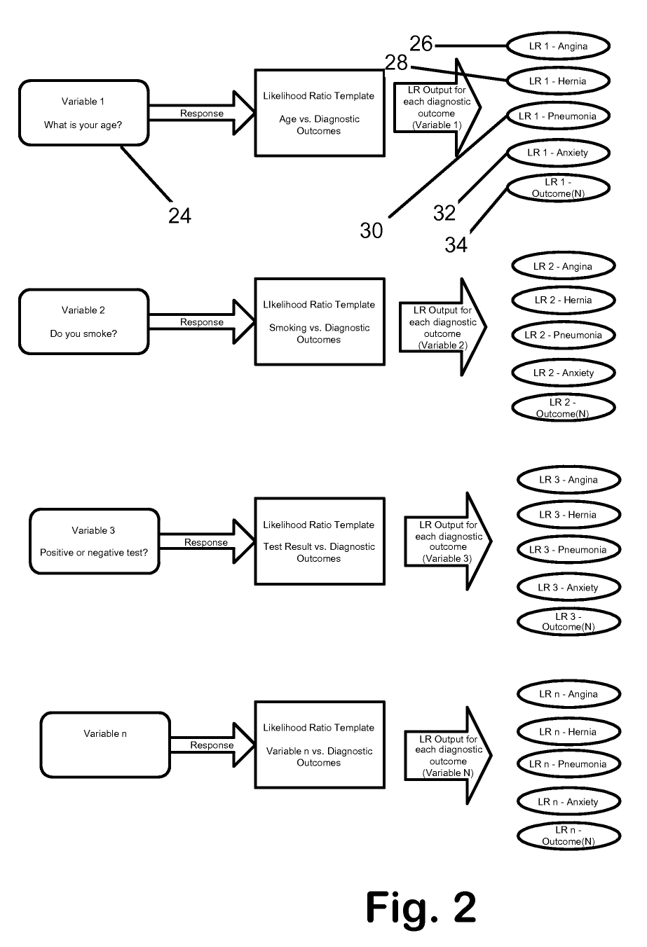

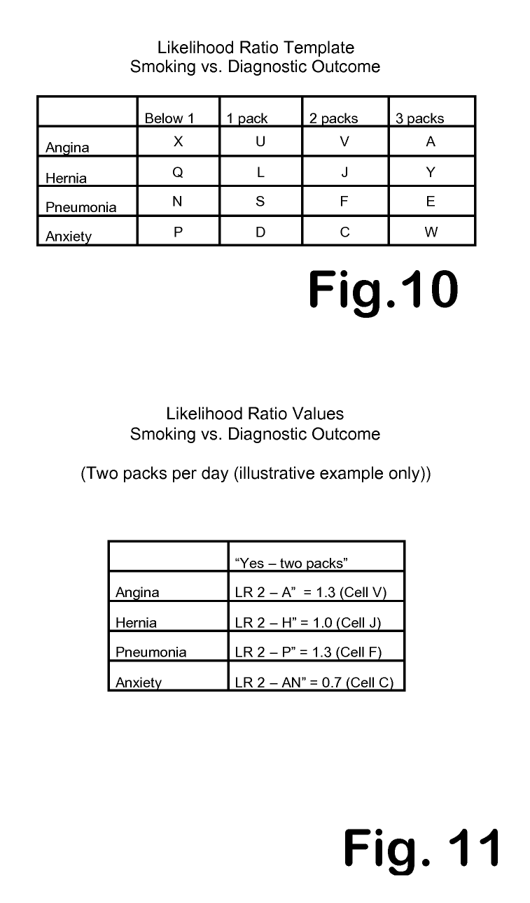

Referring now to FIG. 2, by way of example, if a patient enters a hospital complaining of chest pain, the system may prompt the user to ask the patient the question: “What is your age?” as indicated at 24. The response, which in this case is a response to a first variable (i.e., Variable 1) will cause the system to search the applicable likelihood ratio template or matrix (see, e.g., numeral 16 in FIG. 10 for the applicable likelihood ratios that correspond to the response). It is to be appreciated for the purpose of this disclosure that a “patient response” could be an express answer to a question or even something based on simple observation by the user. Test results work in much the same way but cause different likelihood ratio matrices to be used.

In this particular illustrative example, the system is set up to diagnose four diseases (angina, hernia, pneumonia and anxiety), which means that a likelihood ratio is generated for each one, as indicated at 26, 28, 30, 32. However, it is to be appreciated that the number of diseases or diagnostic outcomes is virtually infinite, which means a likelihood ratio 34 for each outcome “N” can be generated. This example limits diseases to four for ease of discussion and descriptive purposes only.

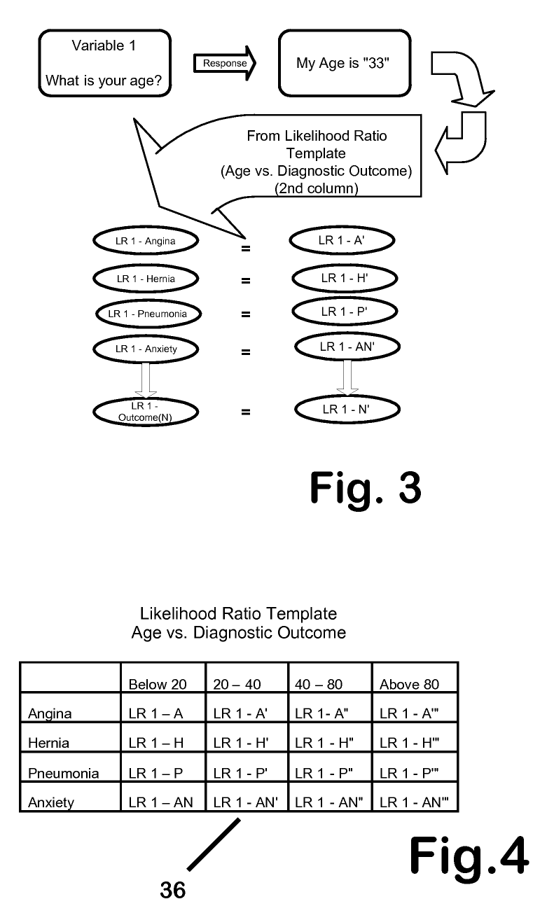

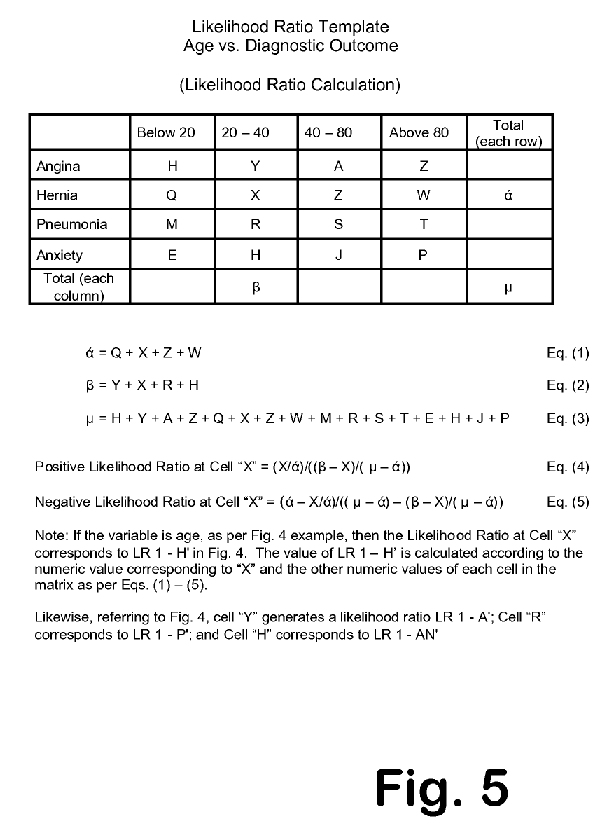

The user inputs the response, which in this example is “My age is 33.” Referring to FIGS. 3 and 4, the response therefore generates likelihood ratio values for each disease in the system that corresponds to that particular response. Referring to FIG. 4, for example, the second data column 36 (or the “20-40” age group) provides likelihood ratios of LR 1-A′; LR 1-H′; LR 1-P′; and LR 1-AN,′ respectively, for diseases angina, hernia, pneumonia and anxiety, within that particular age grouping.

The likelihood ratio values are calculated from cell values that correspond to all of the cell values in a corresponding likelihood ratio matrix, according to the following equations, which are also reproduced in FIG. 5:

\acute{α}=Q+X+Z+W Eq. (1)

β=Y+X+R+H Eq. (2)

μ=H+Y+A+Z+Q+X+Z+W+M+R+S+T+E+H+J+P Eq. (3)

Positive Likelihood Ratio at Cell “X”=(X/\acute{α})/((β−X)/(μ−\acute{α})) Eq. (4)

Negative Likelihood Ratio at Cell “X”=(\acute{α}−X/\acute{α})/((μ−\acute{α})−(β−X)/(μ−\acute{α})) Eq. (5)

Referring to the above equations, “X”=the data value in cell X of a likelihood ratio matrix; “\acute{α}”=the sum of all cell values in the matrix row in which cell “X” is located; “β”=the sum of all cell values in the matrix column in which cell “X” is located; and “μ”=the sum of all cell values in all cells in the matrix. This form of data utilization is consistent for every likelihood ratio matrix of cells that is used to calculate likelihood ratios for the system 10.

FIG. 4 does not identify whether the likelihood ratios illustrated there are “positive” or “negative.” However, the matrix in FIG. 5 represents statistically accrued data that essentially reflects the following: of the total population of patients (which is the total of all cells, or “μ”), then “Y” number of those patients had angina (in the 20 to 40 age group); “X” number had hernia; “R” had pneumonia; and “H” had anxiety. Once again, this is purely statistical information that correlates the answer to the patient's question about age to statistically accrued, objective data.

FIG. 5 also illustrates how the system 10 simplifies the acquisition and accrual of data. The cell values of the matrix simply numbers. To illustrate, if a patient enters a hospital complaining of chest pain, and answers the variable 1 question (“what is your age”), the FIG. 5 matrix simply reflects the recorded statistics that keep track of age versus diagnostic outcome. In other words, according to the specific template shown in FIG. 5, if 1000 patients have been diagnosed, for example, then it is easy to subsequently enter the statistical data for each patient. If the diagnosis was “angina,” for example, the “H” number of the 1000 were in the “below 20” age group; “Y” number in the “20-40” age group; “A” in the “40-80” age group, and so forth. The number “μ,” of course, represents the sum of all cell values (or “1000,” in this example).

The ongoing accumulation of statistics will demonstrate a statistical relationship between diagnoses of disease and age. Presumably, of the 1000 patients (i.e., “μ”), fewer in the “below 20” category, or “H” number, will be diagnosed with angina relative to those in the “40-80” category, or “A” number. These numerical differences are reflected in the likelihood ratios (e.g. FIG. 4) calculated from the cell values of FIG. 5.

In theory, if all the cell values of FIG. 5 are the same (e.g., H=Y=A=R, etc.), then the meaning of the data would be that there is no statistical relevance between age groups and different diseases. This, of course, is not true in reality. However, it illustrates how the accumulation of data could, in fact, cause likelihood ratios to be driven toward a value of “1,” as suggested above.

Let us say, for example, that the patient was 55 years old and diagnosed with “hernia.” In preferred form, the doctor would have used the system 10 to assist in reaching that diagnosis. However, once the doctor concludes that the patient did in fact have a hernia, then the likelihood ratio matrix is updated. That is to say, the value of cell “Z” in FIG. 5 would be increased by “1” (and 1000 increases to 1001 patients in this example). This merely illustrates that long-term data accumulation will cause individual cell values to become different over time, thus reflecting pure, statistical information, and the likelihood ratio calculations consequently become more accurate in time as well—and the effect is automatic.

From the statistical data, positive or negative likelihood ratios can be calculated for each cell value using Equations (4) and (5) above. Therefore, likelihood ratio LR1-H′ in FIG. 4, for example, corresponds to the calculated likelihood ratio value corresponding to the data value in cell “X” in FIG. 5, with one numeric value (positive likelihood ratio) resulting from the use of Equation (4) and a second one (negative likelihood ratio) resulting from use of Equation (5). Each likelihood ratio illustrated in FIG. 4 similarly corresponds to a cell position in the matrix of FIG. 5 in each cell position of the “20-40” age column.

As a consequence, each variable (variable 1 is age related) generates a plurality of likelihood ratio values, one likelihood ratio for each diagnostic outcome that exists in the system (or two for each outcome, if both “positive” and “negative” likelihood ratios are calculated for each outcome). In order to simply the explanation, presume that only positive likelihood ratios are calculated.

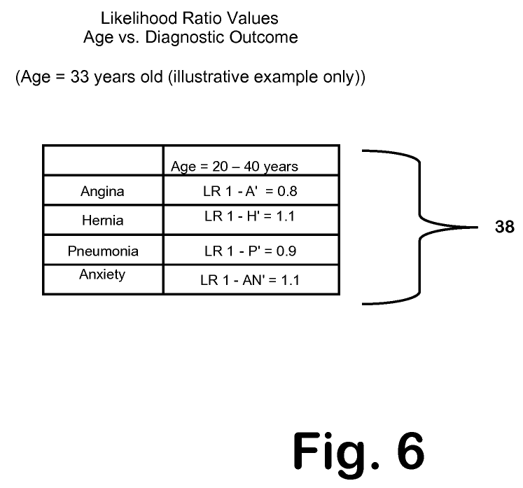

Referring to FIG. 6, reference number 38 indicates mathematical values that result from the likelihood ratio calculation for each cell in the matrix shown in FIG. 5. It is to be appreciated that these numbers are illustrative only and not meant to reflect actual data, as are all the numbers used in this description. However, they illustrate how the system 10 works to simultaneously create a likelihood ratio for each diagnostic outcome in the system as a result of the first variable (age) that is input to the system—the likelihood ratio example for angina is “0.8”; for hernia is “1.1”; for pneumonia is “0.9”; and anxiety is “1.1,” in this example.

Linking the above to the chest pain example, if the patient enters the hospital complaining of chest pain, then an answer of “33” to the question about age (i.e., variable 1) creates likelihood ratios that suggest the complaint is more likely to be related to hernia or anxiety than angina or pneumonia.

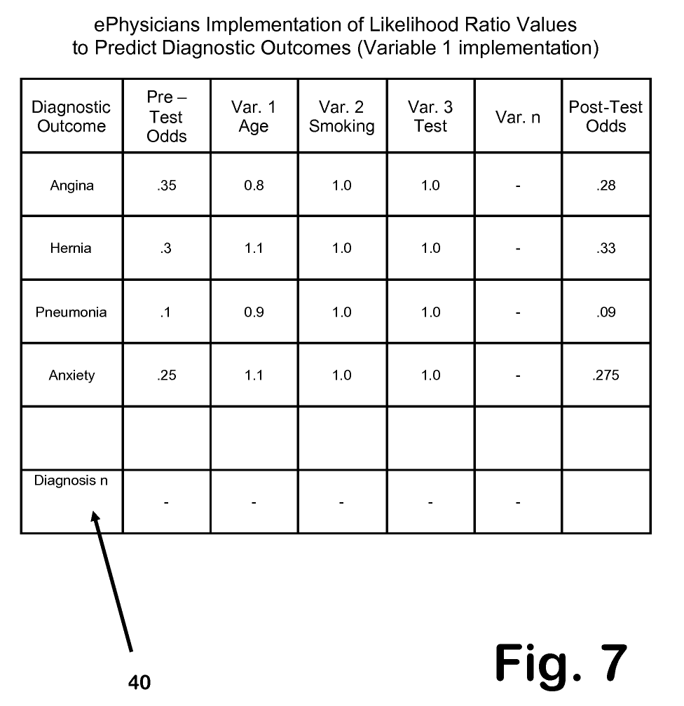

Referring to FIG. 7, these likelihood ratios are multiplied simultaneously against pre-test odds that are statistically generated. Once again, for the sake of illustration only, as soon as a patient complains of chest pain, pre-test odds of the patient having angina might be “0.35”; hernia is “0.3”; pneumonia is “0.1”; and anxiety is “0.25”. Upon answering the question about age, as per the above example, the generated likelihood ratio for angina (0.8) is multiplied against the pre-test odds for angina (0.35) which creates a “post-test” (or post-question) odds number of “0.28,” as reflected in the right-hand column of FIG. 7.

In this instance, the likelihood ratio drove down the diagnostic probability that the patient has angina. Likewise, the generated likelihood ratio for hernia drove up the probability that the patient has a hernia, and so forth, for each diagnostic outcome or disease in the system.

The fundamental math for each diagnostic outcome (each row in the matrix illustrated in FIG. 7) is reflected by the following equation or mathematical array of variables 1 through N:

Pre-test Odds X LR₁ X LR₂ X LR₃ X LRn=Post-test Odds Eq. (6)

Where LR=the likelihood ratio for each diagnostic outcome from one independent variable (LR₁) to the next (LR₂), and so forth, to a likelihood ratio for each of a virtually infinite number of variables (LRn).

In the above example, if the diagnostic outcome being reviewed is “angina,” then Pre-test odds are 0.35, and LR₁ corresponds to 0.8 (or LR 1-A′ in FIGS. 3, 4 and 6). The other likelihood ratios (LR₂ . . . LRn) would be “1” until the variable is input by the user.

At this point it is worthwhile to point out the unlimited scalability of the system in terms of its ability to add diagnostic outcomes or additional variables. It is obvious that any patient entering a hospital with a chest pain complaint could have a larger number of diseases than the ones discussed above for the sake of illustrating the invention. In such case, the likelihood ratio template or matrix corresponding to the age related variable (FIG. 5) is easy to expand in the vertical direction by adding new rows corresponding to different kinds of diseases or added diagnostic outcomes. Likewise, an additional diagnosis (Diagnosis n in FIG. 7) is added to the diagnostic outcomes predicted by the system 10, or calculation matrix, as illustrated at 40 in FIG. 7.

Scalability in the horizontal direction is merely a function of adding new or more variables that can be in the form of questions or test results. The above discussion pertains to the first variable analysis which, as described, altered pre-test odds for all of the diseases in the system. At that point in time, the other likelihood ratios corresponding to other variables remain at “1,” because no questions have been asked or tests conducted, yet. A likelihood ratio of “1” is a neutral number because it neither drives pre-test odds upwardly or downwardly.

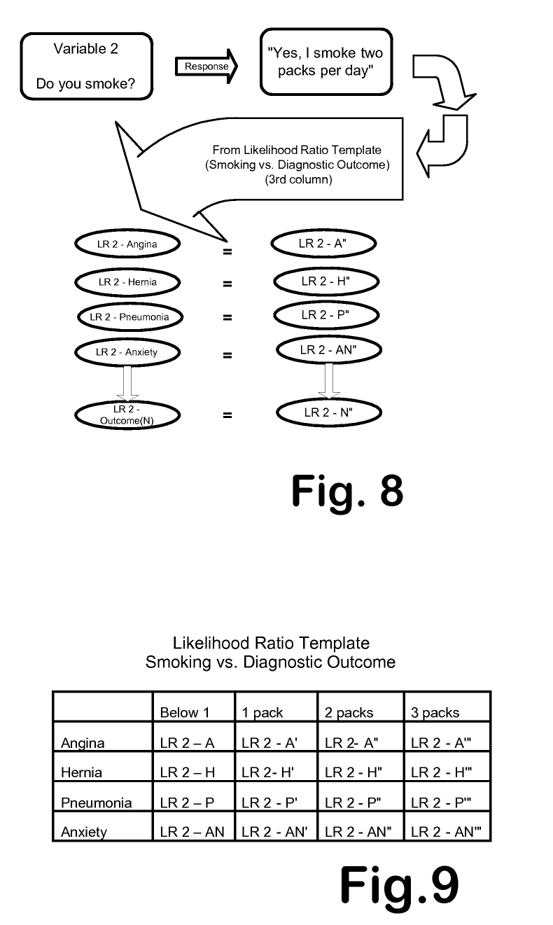

Referring now to FIGS. 2 and 8, the next example of a variable (or “variable 2”) is a second question directed to the patient: “Do you smoke?” An illustrative answer is shown in FIG. 8, which is: “Yes, I smoke two packs per day.” This generates another set of likelihood ratios in the same way as described above, except from a different likelihood template or matrix of values corresponding to variable 2 as generally illustrated in FIGS. 9-11.

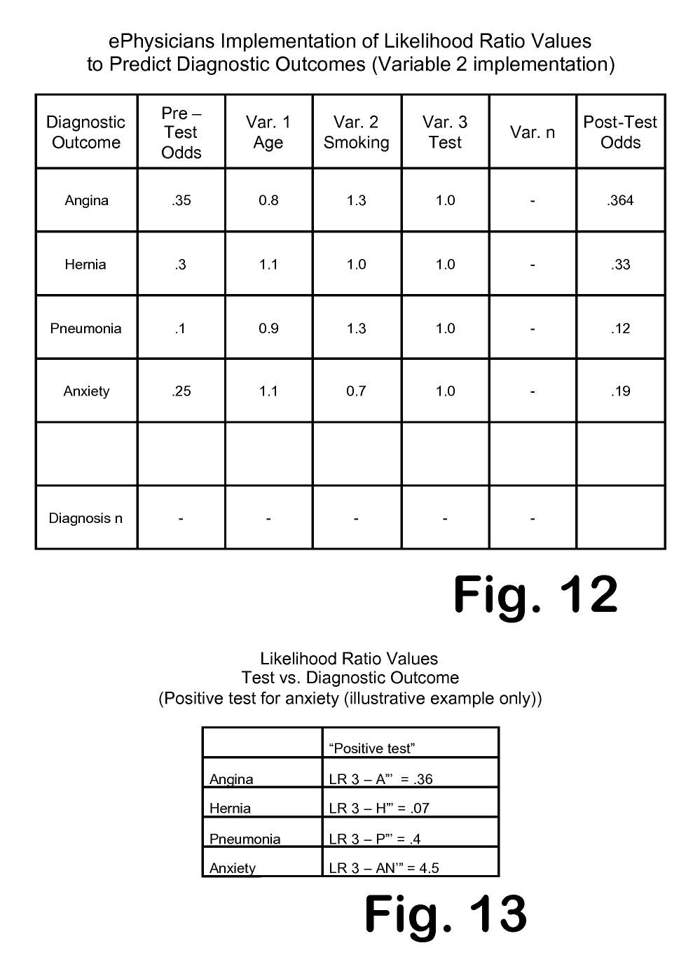

FIG. 10 illustrates a matrix of cells that include statistical data relating to smoking. For example, of the total population in the matrix (the sum of all cells), the number or cell “A” corresponds to the number of the population who smoked three packs of cigarettes a day and were diagnosed with angina; “B” corresponds to the number diagnosed with hernia; “C” corresponds to pneumonia; and “D” corresponds to anxiety. Since, in this example, the patient answered “two packs per day,” then the system selects the cell values from the third column in FIG. 10 (Cells V, J, F, and C) to calculate likelihood ratios (as per the mathematical technique set forth in eqs. (1)-(5) above) that corresponds to each one of these cells (see the third column in FIG. 9). The corresponding values (once again, illustrative examples only) are shown in FIG. 11, and are then multiplied against pre-test odds of each diagnostic outcome as shown in FIG. 12 (once again, using the array equation of eq. (6) above for each disease or diagnostic outcome).

At this point, the likelihood ratio for angina is illustrated as being “1.3”; hernia is “1.0”; pneumonia is “1.3”; and anxiety is “0.7.” Statistically, this simply means that a person who smokes is more likely to have angina or pneumonia than a hernia and less likely to have anxiety than the other diseases. When multiplied in an array, this second variable (variable 2) further adjusts pre-test odds to the numbers reflected in the post-test odds column of FIG. 12.

The next example illustrates how yet another variable (variable 3) can generate likelihood ratios that further adjust post-test odds numbers. Presume that a simple medical test exists, positive or negative, that creates a very high level of certainty that the patient has anxiety, if the test is positive. Unlike the “greater than” 2×2 statistical matrices traditionally used to calculate likelihood ratios, as illustrated in FIGS. 5 and 10, the matrix for a positive and negative test may be 2×4 (in the example described here) or some other matrix greater than 2×2 (e.g., 2×6, or 2×N, depending on the number of diagnostic outcomes in the system).

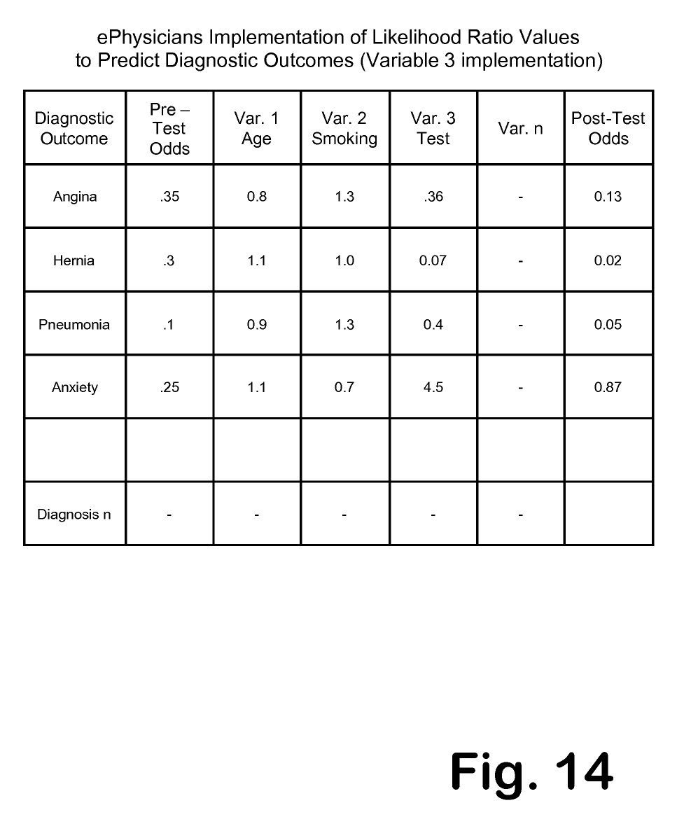

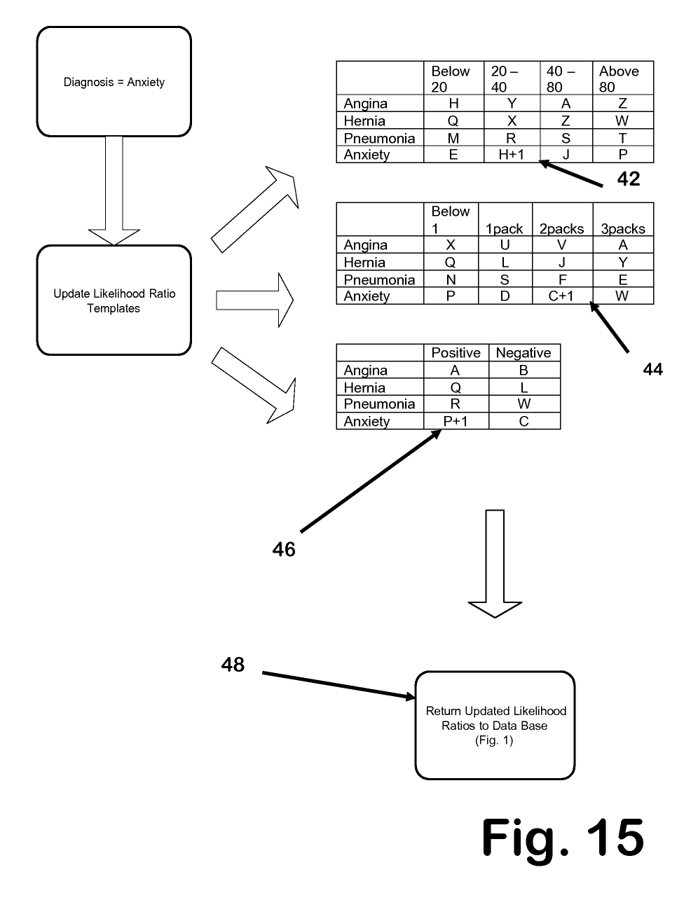

In such case, a very high likelihood ratio will be generated for “anxiety” (e.g., “4.5”) while much lower likelihood ratios will be generated for the other outcomes, as illustrated in FIG. 13. These values are inserted into the calculation matrix as a third independent variable multiplication factor (variable 3) and impact post-odds numbers in the way, depending on variable value. Comparing FIG. 14 to FIG. 12, or to FIG. 7, merely illustrates that a highly certain test creates likelihood ratio values that shift post-test odds to a different diagnostic outcome. In the scenario described, after the first variable was entered, the patient appeared to have a hernia. Then, after the second variable, the odds shifted to indicate angina was most likely. After the test, the odds shifted again to indicate anxiety.

For the sake of explaining terminology used here, terms like “test results,” etc. should be taken to mean lab tests undertaken in the usual way, but they could also mean simple tests based on observation. In some instances, the line between a patient response and a test result can be blurred. Therefore, reference to “patient responses and test results” should be taken to mean that a piece of data was acquired that leads to the creation of a variable or underlying likelihood ratio, in accordance with the description set forth here.

As mentioned above, the system 10 is meant to serve as a guide to a medical diagnosis. As per the above exemplary description, three variables (that can be expanded infinitely in number) lead to an indication that the patient was having an anxiety attack. Once the doctor confirms the diagnosis, then that confirmation is used to update each likelihood ratio template or matrix in the system.

Referring now to FIG. 15, and as was described previously, each data template is nothing more than a matrix of cells, each one having a number. In the foregoing example, the system 10 indicated that the patient was suffering from anxiety. Assume the doctor concluded that anxiety was the proper diagnosis. The patient was age 33, smoked two packs of cigarettes per day, and tested positive for anxiety. Therefore, the corresponding number in each corresponding likelihood matrix cell is updated by “1” accordingly. Whereas “H” number of patients in the 20-40 age group were diagnosed with anxiety prior to analyzing the new patient, that number is updated to “H+1” (reference number 42 in FIG. 15) afterward. Likewise, the accrued data matrices relating to smoking and test are updated in the same way (reference numbers 44 and 46) and “μ” is also increased. This creates corresponding updates in the likelihood ratio calculations relating to each cell on an instantaneous basis as per the mathematical calculations illustrated on FIG. 5. When the next patient enters a hospital complaining of chest pain where the system is in use, the system works off of the updated likelihood ratios, as indicated at 48 in FIG. 15, but the diagnostic process remains the same.

The ongoing accrual of data can be used to update and refine pre-test odds in the system, which is reflected in examples illustrated in the first column of FIGS. 7, 12 and 14. This portion of the system is much more straight forward and dependent on the actual diagnosis made as part of a patient population, which is well-known. In initial implementations of the system 10, it is anticipated that pre-test odds numbers may be derived from existing statistics that come from other sources. As the system is used over time, however, diagnostic results related to use of the system may be used to create and update pre-test odds on an ongoing basis.

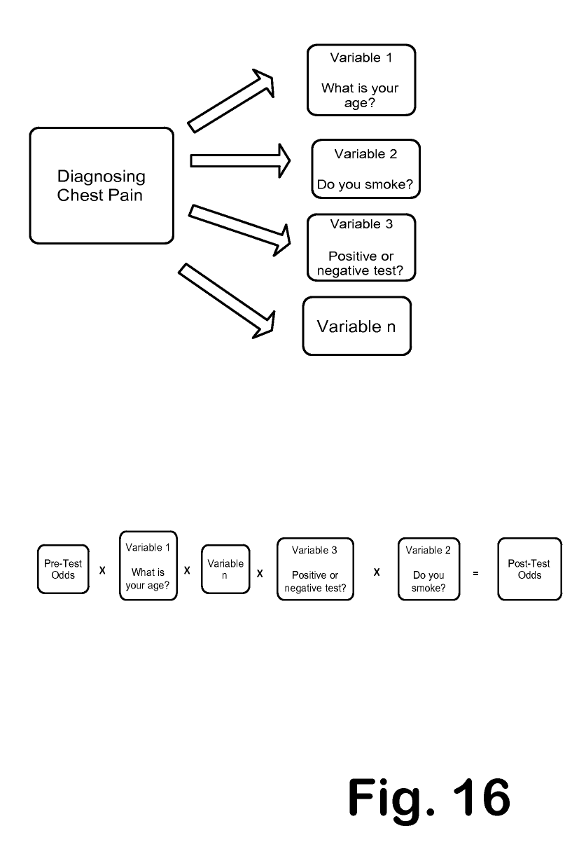

As mentioned above, and as is schematically indicated in FIG. 16, the system 10 has the capability of adding virtually an unlimited number of variables, each one of which is independent of the other in each calculation “row” of the calculation matrix. This provides significant advantages to the software programmer because of the ease of both adding new data and making adjustments. As reflected in FIG. 16, the programmer can easily switch the order that variables are multiplied in an array against each other, if time shows that some variables are more powerful in reaching a diagnosis than others. Essentially, the independent nature of each variable that creates a likelihood ratio, which is multiplied as a factor in an array against a pre-test odds number (i.e., eq. (6) above), carries through to software code. It should be appreciated that the likelihood ratios in each “column” of the calculation matrix illustrated in FIGS. 7, 12 & 14 are “dependent” because all are generated upon a single variable—corresponding to the number of diseases or outcomes diagnosed by the system. In other words, each likelihood ratio column in the calculation matrix stands alone with respect to the underlying template and matrix used to create the likelihood ratio, so that programming changes, or additions or deletions of likelihood ratio matrices, can be done independently without altering other likelihood ratio calculations. Similarly, when and if likelihood ratios are added to or subtracted from the calculation matrix, code writing is simplified because software logic associated with making these changes is divorced from the sequence and ordering of a rules-based system.

The software can be written to implement the system 10 in various ways. With respect to the calculation of likelihood ratios, for example, the software may be written to calculate likelihood ratios from underlying cell data and then place them in a look-up table for use when a diagnostic procedure begins or calculate them on a running basis, depending on system resources or reasons relating to efficiency. The updating of likelihood ratio matrices will be driven by system efficiencies. It is possible to update the matrices after each diagnosis. In a large, networked system that accumulates large amounts of data, the system may be updated based on time periods (e.g., once a day, once a month, etc.) or when certain thresholds are reached regarding the ever expanding size of the patient population in the system (e.g., when the patient population is 1000, then 1500, then 2000, etc.).

While it is believed that a web-based system provides the best mechanism for wide-spread use, it is also possible to use the system 10 as a stand-alone or within a closed network of any medical facility that is large enough to create statistically relevant data. The system 10 could be dedicated to treating certain kinds of ailments, if desired, although it is easily expanded and adapted to virtually any ailment that is subject to the statistical accumulation of data.

The above description is for illustrative purposes only and is not meant to limit the scope of the invention. Reference is made to the prior applications identified above, upon which this application is based as a continuation. The matrix concept of calculating likelihood ratios, according to the above description, and applying them in a multiplication array against a pre-test odds number to create a post-test result makes up the foundation of the earlier applications. The present disclosure is an evolutionary step forward from the initial disclosure in that it carries through the concept of using one variable to simultaneously generate a multiple number of likelihood ratios that are applied against the various diagnostic outcomes in a calculation matrix, all at the same time. The invention described here is to be limited only by the claims that follow, the interpretation of which is to be made in accordance with the standard doctrines of claim interpretation.

What is claimed:

1. A system for diagnosing medical outcomes, comprising:
a web-based diagnostic system that is accessible by a user for diagnosing patient diseases, wherein in response to patient responses and test results, the system creates at least one array of factors including a pre-test odds factor and a plurality of likelihood ratios that are multiplied against the pre-test odds factor to produce a post-test odds factor, wherein each likelihood ratio is calculated from the likelihood ratio's matrix of cell values, and still further, the calculation of each likelihood ratio being based on the total value of all cells in the matrix that corresponds to the likelihood ratio.

2. The system of claim 1, wherein the likelihood ratio's matrix of cell values is greater than a 2×2 matrix.

3. The system of claim 1, wherein each likelihood ratio matrix of cell values is updated for all likelihood ratios in the array upon successful diagnosis of a patient.

4. The system of claim 1, wherein likelihood ratios are calculated according to the following mathematical equations:
Positive Likelihood Ratio at Cell “X”=(X/\acute{α})/((β−X)/(μ−\acute{α}))
Negative Likelihood Ratio at Cell “X”=(\acute{α}−X/\acute{α})/((μ−\acute{α})−(β−X)/(μ−\acute{α}))
Wherein
“X”=the data value in cell X of a likelihood ratio matrix;
“\acute{α}”=the sum of all cell values in the matrix row in which cell “X” is located;
“β”=the sum of all cell values in the matrix column in which cell
“X” is located; and
“μ”=the sum of all cell values in all cells in the matrix

5. A system for diagnosing medical outcomes, comprising:
a web-based diagnostic system that is accessible by a user for diagnosing patient diseases, wherein in response to patient responses and test results, the system creates a calculation matrix that includes a report for each diagnostic outcome available from the system, each diagnostic outcome being predicted by an array of factors that includes a pre-test odds factor for the diagnostic outcome and a plurality of likelihood ratios in the array that are multiplied against the pre-test odds factor to produce a post-test odds factor, wherein a patient response or test result generates a likelihood ratio for each diagnostic outcome in the system, to recalculate all post-test odds in the calculation matrix upon entry of a patient response or test result in a substantially simultaneous manner.

6. The system of claim 4, wherein the likelihood ratio generated for each diagnostic outcome as a result of a patient response or test result is mathematically represented in a column of a calculation matrix, with all the likelihood ratios for the column being calculated from a simple likelihood ratio matrix.

7. The system of claim 4, wherein each likelihood ratio in an array in the calculation matrix corresponding to a single diagnostic outcome reported by the system is mathematically independent of other likelihood ratios in the same array.

8. A system for diagnosing medical outcomes, comprising:
a web-based diagnostic system that is accessible by a user for diagnosing patient diseases, wherein in response to patient responses and test results, the system creates likelihood ratios that are multiplied against the pre-test odds factors to produce a post-test odds factors, wherein each likelihood ratio is calculated from a matrix of cell values, the size of the matrix of cell values being greater than a 2×2 matrix, and still further, the calculation of each likelihood ratio being based on the total value of all cells in the matrix that corresponds to the likelihood ratio.

9. The system of claim 7, wherein likelihood ratios are calculated according to the following mathematical equations:
Positive Likelihood Ratio at Cell “X”=(X/\acute{α})/((β−X)/(μ−\acute{α}))
Negative Likelihood Ratio at Cell “X”=(\acute{α}−X/\acute{α})/((μ−\acute{α})−(β−X)/(μ−\acute{α}))
Wherein
“X”=the data value in cell X of a likelihood ratio matrix;
“\acute{α}”=the sum of all cell values in the matrix row in which cell “X” is located;
“β”=the sum of all cell values in the matrix column in which cell “X” is located; and
“μ”=the sum of all cell values in all cells in the matrix
